(19) United States
(12) Patent Application Publication
(10) Pub. No.: US 2015/0283555 A1
(43) Pub. Date: Oct. 8, 2015

(54) Isolation of Single Molecule of Solid Organic Compound By Dual Microencapsulation

(71) Applicant: DHKGraphenologies LLC, San Jose, CA (US)

(72) Inventors: Nguyen C. Khe, Ho Chi Minh City (VN); Hieu Dinh, San Jose, CA (US); Dien Dinh, San Jose, CA (US)

(73) Assignee: DHKGraphenologies LLC, San Jose, CA (US)

(21) Appl. No.: 14/244,864

(22) Filed: Apr. 3, 2014

(51) Int. Cl. B03C 7/02

(52) U.S. Cl. CPC B03C 7/023

(57) ABSTRACT

Certain exemplary embodiments can provide a method, which can comprise isolating a single molecule of a solid organic compound via a microencapsulation process. The single molecule can be adapted for use in at least one of a drug, pharmaceutical application, microelectronic device, bioengineering application, biomedical product, agricultural product, or agricultural medicine. The microencapsulation process can comprise (1) adsorbing the single molecule on a template; and (2) dividing the template into species using electrostatic charge generating molecules.

### CROSS-REFERENCES TO RELATED APPLICATIONS

This application is related to pending U.S. patent application Ser. No. 13/290108 (Attorney Docket No. 1200-003), filed 7 Nov. 2011.

### BRIEF DESCRIPTION OF THE DRAWINGS

A wide variety of potential practical and useful embodiments will be more readily understood through the following detailed description of certain exemplary embodiments, with reference to the accompanying exemplary drawings in which:

FIG. 1 is a graph 1000 of a Raman spectra of graphene having substantially a single layer structure;

FIG. 2 is a graph 2000 of a Raman spectra of graphene having more than substantially one layer, substantially bi-layer, and a few-layers;

FIG. 3 is a graph 3000 of a Raman spectra of graphite, graphene oxide (GO) and reduced graphene oxide (RGO);

FIG. 4 is a graph 4000 of a Raman spectra of physically functionalized graphene (monolayer) from an exemplary embodiment;

FIG. 5 is a graph 5000 of a Raman spectra of physically functionalized graphene hybrid composite (GHC) from an exemplary embodiment;

FIG. 6 is a graph 6000 of a Raman spectra for exemplary graphene oxide from an exemplary embodiment;

FIG. 7 is a graph 7000 of a Fourier transform infrared spectroscopy (“FtIR”) chart of a graphene product converted by chemical reduction agent from a physically functionalized graphene according to an exemplary embodiment;

FIG. 8 is a graph 8000 of an FtIR chart of a graphene oxide product from an exemplary embodiment;

FIG. 9 is a graph of 9000 of an FtIR chart of a graphene hybrid composite (GHC) converted by chemical reduction agent from a physically functionalized GHC from an exemplary embodiment;

FIG. 10 is a flow chart of process producing physically functionalized mono layer graphene and GHC from an exemplary two step microencapsulation process;

FIG. 11 is a scanning electron microscopy (“SEM”) image of an organic molecule after two steps of a microencapsulation process;

FIG. 12 shows the process of isolation organic molecule cluster into single molecule using a two-step microencapsulation technique;

FIG. 13 is a block diagram of a continuous production reactor 13000; and

FIG. 14 is a flowchart of an exemplary embodiment of a method 14000.

### DETAILED DESCRIPTION

Certain exemplary embodiments can provide a method, which can comprise isolating a single molecule of a solid organic compound via a microencapsulation process. The single molecule can be adapted for use in at least one of a drug, pharmaceutical application, microelectronic device, bioengineering application, biomedical product, agricultural product, or agricultural medicine. The microencapsulation process can comprise (1) adsorbing the single molecule on a template; and (2) dividing the template into species using electrostatic charge generating molecules.

Certain exemplary embodiments can provide a physically functionalized graphene and graphene hybrid composite (GHC) using isolated single molecule of carbon sources prepared by the disclosed dual microencapsulation process. The graphene and GHC can be formed between specific nano carbon materials and graphene generated via pyrolysis of specific precursor made out of single molecule of solid carbon sources. A Raman spectrum of the physically functionalized GHC monolayer can show a major 2D band at approximately 2650 l/centimeter, a minor D and G band at approximately 1350 l/centimeter and approximately 1575 l/centimeter, and an intensity ratio of 2D band over D band and G band greater than 1. A Raman spectrum of the physically functionalized graphene monolayer can show a major 2D band at approximately 2650 l/centimeter, a minor G band at approximately 1575 l/centimeter, and an intensity ratio of 2D band over G band greater than 1

Carbon can have four unique crystalline structures comprising diamond, graphite, fullerene, and carbon nano-tubes. Carbon can form many products having different physical structures. Certain exemplary carbon structures can be classified as follows:
Carbon nano tube. The phrase “carbon nano-tube” (“CNT”) refers to a tubular structure, which can be grown with a single wall or multi-walls. A CNT can be conceptually visualized as rolling up a graphene sheet or several graphene sheets to form a concentric hollow structure. CNTs have a diameter on the order of a few nanometers to a few hundred nanometers.
Graphite is a crystalline, low density and soft allotrope of carbon. The crystalline structure of graphite consists of hexagonal rings forming thin parallelplates. Graphite has a layered, substantially planar structure. In each layer, the carbon atoms are arranged in a hexagonal lattice with separation of approximately 0.142 nanometers (“nm”), and the distance between planes is approximately 0.335 nm and the layers from each planes layers are bonded to each other by Van der Waals forces, which are relatively weak compared to covalent bonds. Two forms of graphite, alpha (hexagonal) and beta (rhombohedral), have very similar physical properties (except that the graphene layers stack slightly differently). The hexagonal graphite can be either flat or buckled. The alpha form can be converted to the beta form through mechanical treatment and the beta form can revert to the alpha form when it is heated above approximately 1300 degrees Celsius. The layering contributes to its relatively low density.
Graphene can be formed by isolating graphite layers into a single layer product. Pure graphene product has a substantially single layer structure which can have superior electronic and mechanical properties. Graphene can also be a bilayer structure product or a product having a few layers, which can be called a graphene nano platelet.

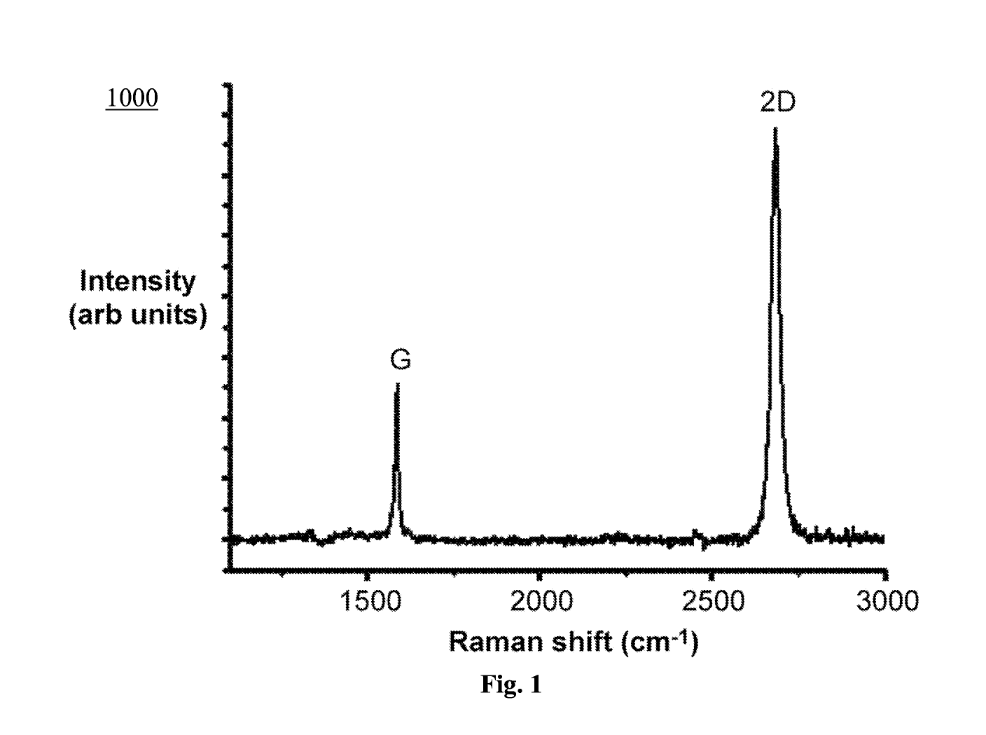

Raman spectroscopy can be used to identify each kind of graphitic carbon materials including graphite, graphene, graphite and graphene oxide, carbon nano tubes, fullerenes, and/or diamonds, etc. FIG. 1 is a graph 1000 of a Raman spectra of graphene having substantially a single layer structure, which shows a small G band at approximately 1582 cm⁻¹ and a relatively large 2D band (which might also be named “G”) at approximately 2640 cm⁻¹.

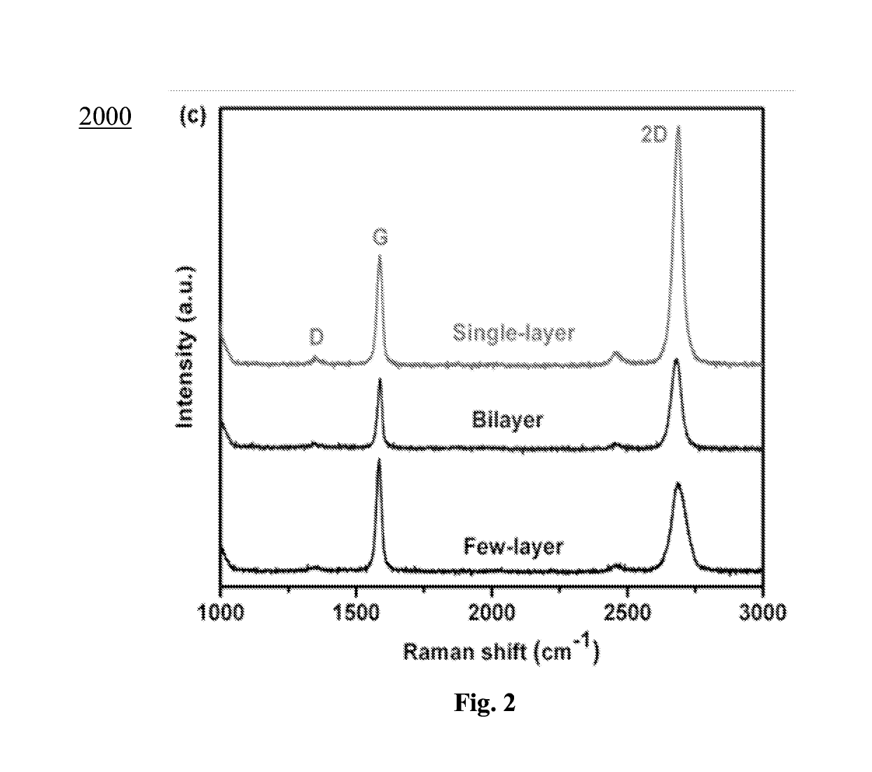

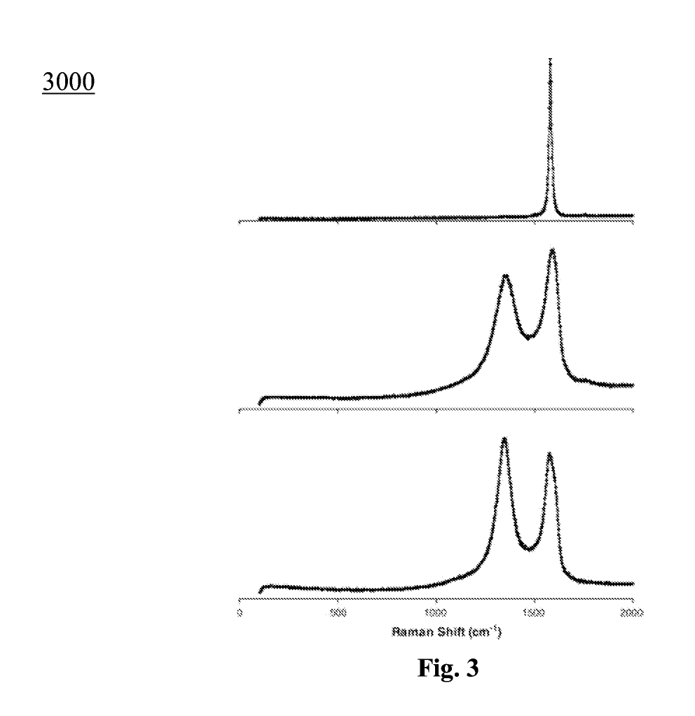

FIG. 2 is a graph 2000 of a Raman spectra of graphene having more than substantially one layer; substantially bi-layer, and a few-layers. FIG. 3 is a graph 3000 of a Raman spectra of graphite, graphene oxide (GO) and reduced graphene oxide (RGO). FIG. 3 shows Raman spectra for graphite (top), graphene oxide (middle), and reduced graphene oxide (bottom).

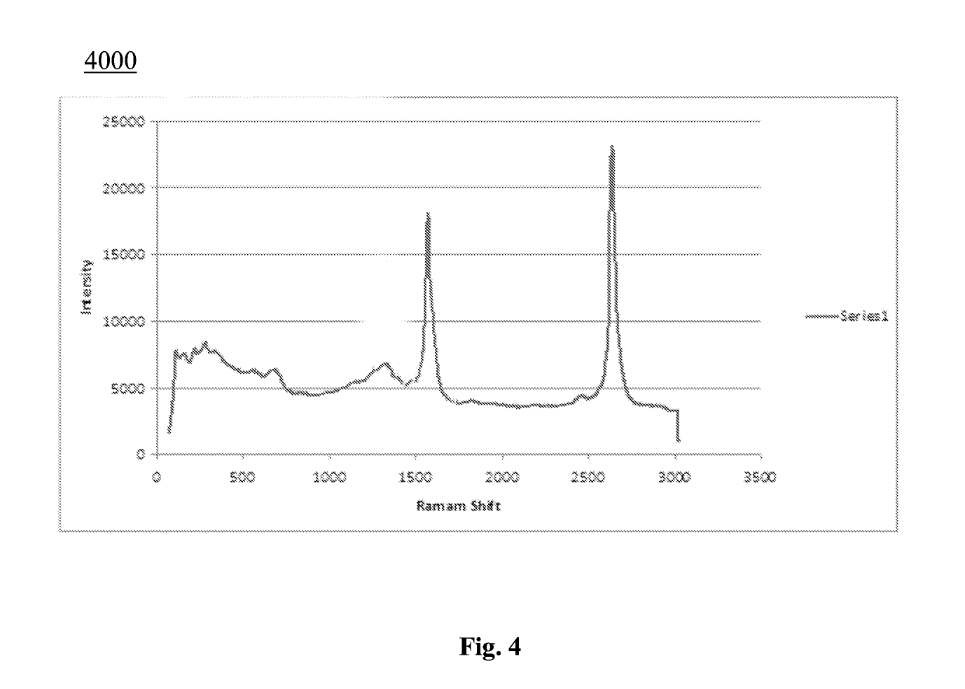

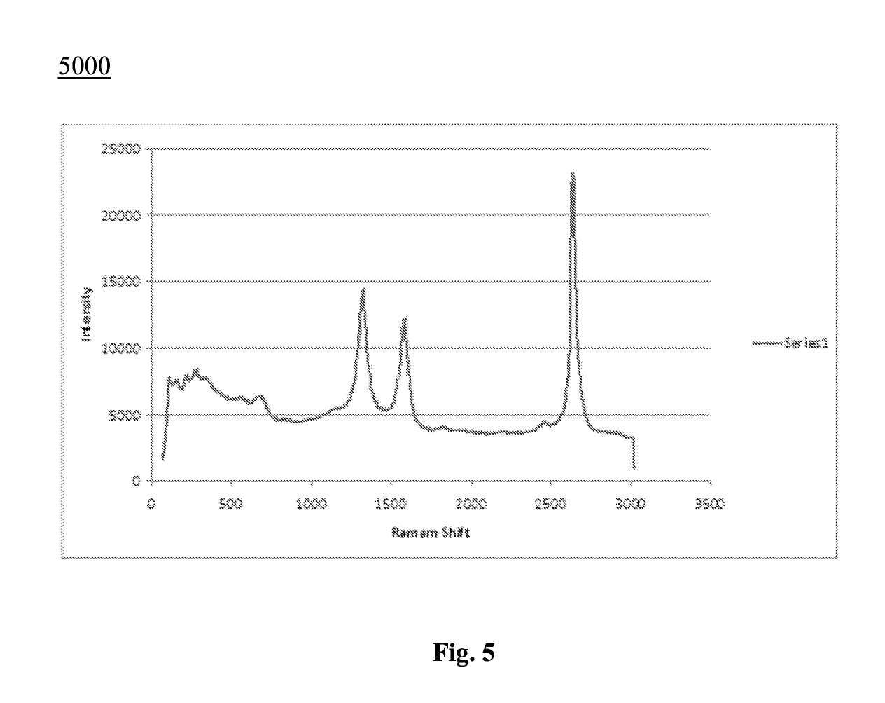

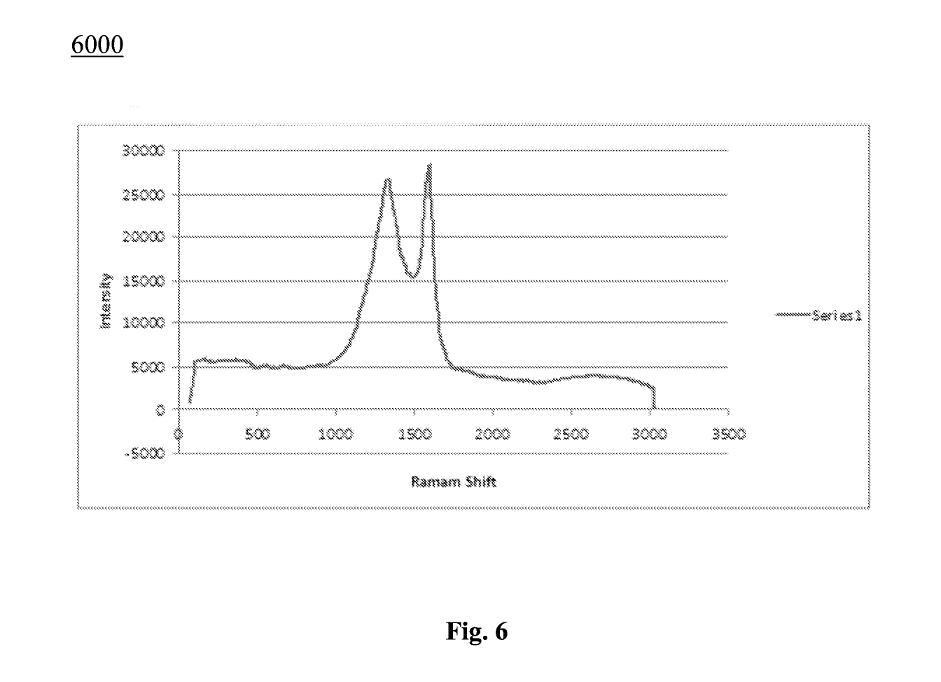

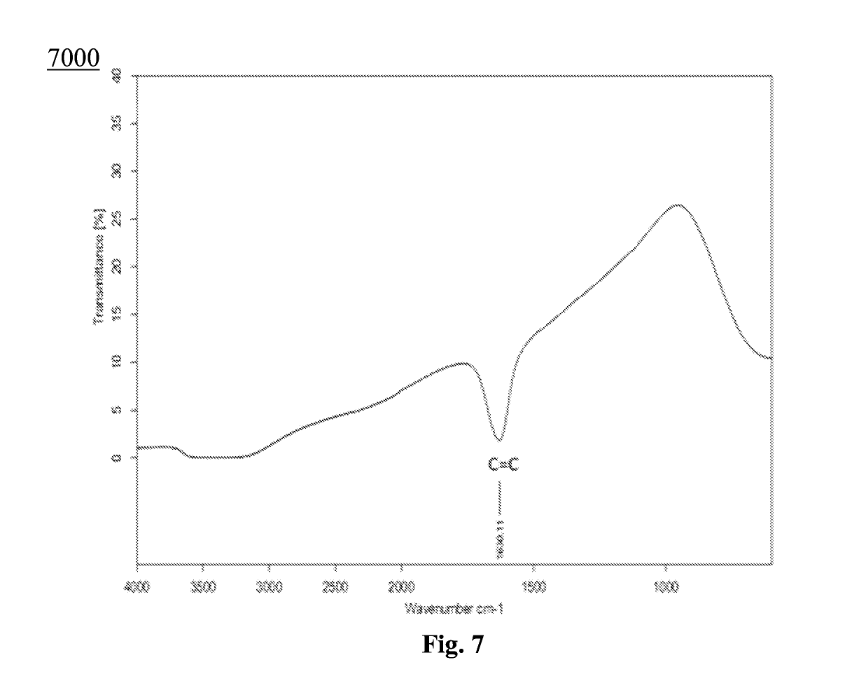

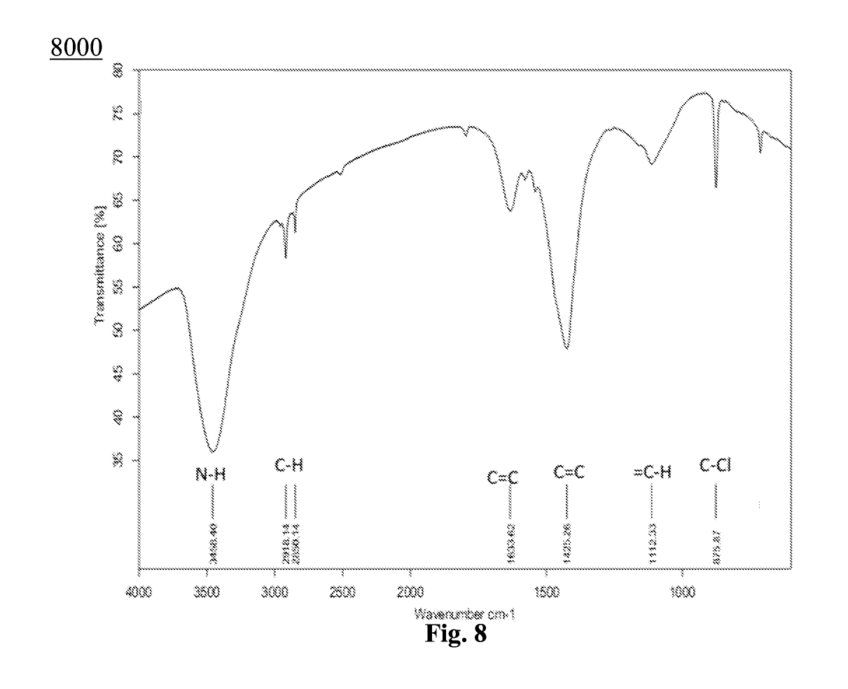

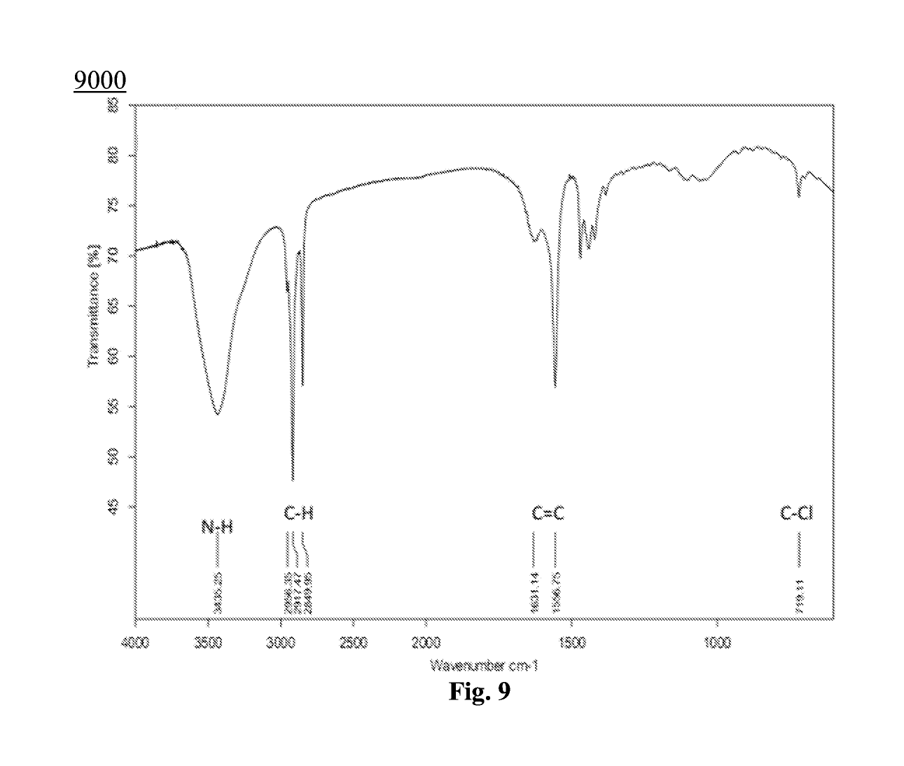

FIG. 4 is a graph 4000 of a Raman spectra of graphene (monolayer) from an exemplary embodiment. FIG. 5 is a graph 5000 of a Raman spectra for an exemplary graphene hybrid composite (GHC) from an exemplary embodiment. FIG. 6 is a graph 6000 of a Raman spectra for an exemplary graphene oxide (GO) from an exemplary embodiment. FIG. 7 is a graph 7000 of an FtIR chart of a graphene product converted by chemical reduction agent from physically functionalized graphene according to an exemplary embodiment. FIG. 8 is a graph 8000 of an FtIR chart of a graphene oxide product from an exemplary embodiment. FIG. 9 is a graph of 9000 of an FtIR chart of a graphene hybrid composite (GHC) converted by chemical reduction agent from a physically functionalized GHC from an exemplary embodiment.

Graphene is a crystalline form of carbon, as are diamond, graphite, carbon nanotubes and fullerenes. In graphene, carbon atoms are arranged in a substantially regular hexagonal pattern. Graphene can be described as a one-atom thick layer of the layered mineral graphite. Graphene is an allotrope of carbon, whose structure is substantially one-atom-thick planar sheets of sp-bonded carbon atoms that are packed in a honeycomb crystal lattice. Graphene can be visualized as an atomic-scale sheet made of carbon atoms and their bonds. The crystalline or “flake” form of graphite consists of many graphene sheets stacked together. In essence, single layer graphene is substantially an isolated atomic plane of graphite.

Graphite Oxide, Graphene Oxide and Graphene. While graphite is a three dimensional carbon based material made up of millions of layers of graphene, graphite oxide (“GO”) is different. In GO each carbon layer is separated with oxygen molecules, which not only expand the layer separation, but also enable the layers to become hydrophilic (meaning that they can be dissolved in water, much like sugar or salt). This property enables GO to be exfoliated in water using sonication, ultimately producing GO having a single layer or a few layers. Graphene oxide is graphite that has been oxidized to intersperse the carbon layers with oxygen molecules, and then reduced, to separate the carbon layers into graphene having one to a few layers.

Sometimes graphene oxide is referred to as GO, which is also the chemical formula for graphite oxide. However, “r-GO” is a chemical formula for reduced graphite oxide, which is effectively graphene oxide. Reducing graphene oxide to produce graphene monolayers can be challenging. While it is possible to reduce graphene oxide to graphene by using hydrazine hydrate, hydrazine hydrate is relatively strong and poisonous. Also, the reduction of graphene oxide using hydrazine hydrate may still contain some impurities such as oxygen or even nitrogen, due to the reaction between the GO and hydrazine hydrate. Sodium borohydride can be a potential replacement for hydrazine hydrate and can result in better yields.

Graphene can be produced using mechanical or thermal exfoliation, chemical vapor deposition (“CVD”), and/or epitaxial growth, etc. Graphene can also be produced via chemical reduction. Graphite oxide can be produced by combining sodium nitrate, potassium permanganate and sulphuric acid.

Exfoliated graphene can be obtained via micro-mechanical alleviation of graphite.

Adhesive tape can be applied repeatedly to split graphite crystals into increasingly thinner pieces. Tape with attached optically transparent flakes can be dissolved in acetone, and, after a few further steps, the flakes including monolayers can be sedimented on a silicon wafer. Individual atomic planes can be examined with an optical microscope. Certain exemplary embodiments can utilize substantially dry deposition, avoiding a stage when graphene floated in a liquid. Relatively large crystallites (first, only a few micrometers in size but eventually larger than 1 mm and visible to the naked eye) can be obtained thereby. Such a technique can be referred to as a scotch tape or drawing method. The latter name can be used because the dry deposition resembles drawing with a piece of graphite the key for the success might be the use of relatively high-throughput visual recognition of graphene on a selected substrate, which can provide a small but noticeable optical contrast.

Epitaxial growth on silicon carbide. Another method of obtaining graphene is to heat silicon carbide (“SiC”) to relatively high temperatures (greater than approximately 1,100 degrees Celsius) under relatively low pressures (approximately 10⁻⁶ ton) to reduce the SiC to graphene. Such a process produces epitaxial graphene with dimensions dependent upon the size of the SiC substrate (wafer). The face of the SiC used for graphene formation, silicon- or carbon-terminated, highly influences the thickness, mobility and carrier density of the graphene.

Epitaxial growth on silica Graphene can be grown on a silica substrate for relatively high-frequency transistors.

Epitaxial growth on metal substrates. Carbon sources and an atomic structure of a metal substrate can be used to seed the growth of graphene (epitaxial growth). Due to the long-range order of these ripples, generation of mini- gaps in the electronic band-structure (Dirac cone) becomes visible. High-quality sheets of graphene having a few-layers exceeding approximately one square centimeter (approximately 0.2 square inches) in area have been synthesized via CVD on thin nickel films with methane as a carbon source. Such sheets have been successfully transferred to various substrates, demonstrating viability for numerous electronic applications.

Copper foil can be employed; at very low pressure, the growth of graphene automatically stops after a single graphene layer forms, and relatively large graphene films can be created. The aforementioned single layer growth is also due to the low concentration of carbon in methane. Higher molecular weight hydrocarbon gases, such as ethane and propane, can lead to the growth of bilayer graphene. At atmospheric-pressure CVD growth, multilayer graphene can also form on copper (similar to that grown on nickel films). Growth of graphene can take place at temperatures compatible with complementary metal oxide semiconductor (“CMOS”) processing, using a nickel-based alloy with gold as a catalyst.

Graphite oxide reduction. Graphite oxide reduction can yield substantially mono layer flakes of reduced graphene oxide. Graphite oxide exfoliation can be achieved by rapid heating and yields highly dispersed carbon powder with a few percent of graphene flakes. Graphene films can be produced via a reduction of graphite oxide monolayer films such as, for example, by hydrazine and/or annealing in argon/hydrogen. However, the quality of graphene produced by graphite oxide reduction can be lower compared to, for example, scotch-tape graphene due to incomplete removal of various functional groups by existing reduction methods. Furthermore, the oxidation protocol can introduce defects due to over-oxidation. The oxidation protocol can be enhanced to yield graphene oxide with an almost intact carbon framework that allows the highly efficient removal of functional groups. The measured mobility of charge carriers can exceed approximately 1000 square centimeters/volt seconds for good quality flakes. Applying a layer of graphite oxide film to a DVD disc and burning it in a DVD writer can result in a thin graphene film with a relatively high electrical conductivity (approximately 1738 siemens per meter) and specific surface area (approximately 1520 square meters per gram), besides being highly resistant and malleable.

Growth from metal-carbon melts. Carbon atoms can be dissolved inside a transition metal melt at a certain temperature, and then the dissolved carbon can be allowed to precipitate out at lower temperatures as substantially single layer graphene (SLG). The metal can be first melted in contact with a carbon source. The carbon could be the graphite crucible inside which the melting process is carried out or it could be a graphite powder or chunk sources, which are simply placed in contact with the melt. Keeping the melt in contact with carbon source at a given temperature can give rise to substantial dissolution and saturation of carbon atoms in the melt based on the binary phase diagram of metal-carbon. Upon lowering the temperature, solubility of the carbon in the molten metal will decrease and the excess amount of carbon will precipitate on top of the melt. The floating layer can be either skimmed or allowed to freeze for removal afterwards. Different morphology including thick graphite, few layer graphene (FLG) and SLG have been observed on metal substrate. Raman spectroscopy proves that SLG can be successfully grown on nickel substrate. The SLG Raman spectrum showed virtually no D and D′ band, indicating the pristine and high-quality nature of SLG. Among transition metals, nickel provides a better substrate for growing SLG. Since nickel is not Raman active, the direct Raman spectroscopy of graphene layers on top of the nickel is achievable. The graphene-metal composite can be utilized in thermal interface materials for thermal management applications.

Pyrolysis of sodium ethoxide. A process can be used to produce gram-quantities of graphene via the reduction of ethanol by sodium metal, followed by pyrolysis of the ethoxide product, and washing with water to remove sodium salts.

From nanotubes. Methods for the production of graphene ribbons can comprise cutting open nanotubes. In one such method multi-walled carbon nanotubes can be cut open in solution by action of potassium permanganate and sulfuric acid. In another method graphene nano ribbons can be produced by plasma etching of nanotubes partly embedded in a polymer film.

From graphite by sonication. Graphite can be dispersed in a proper liquid medium that is then sonicated. Non exfoliated graphite is eventually separated from graphene by centrifugation. In certain exemplary embodiments, graphene concentration up to approximately 5.3 mg/ml in N-methylpyrrolidone (NMP) can be obtained. In certain exemplary embodiments, a suitable ionic liquid can be used as a dispersing liquid medium for graphite exfoliation.

Carbon dioxide reduction method. A synthesis process involving a highly exothermic reaction in which magnesium is combusted in an oxidation-reduction reaction with carbon dioxide can be used to produce a variety of carbon nanoparticles including graphene and fullerenes. The carbon dioxide reactant maybe either solid (dry-ice) or gaseous. The products of this reaction are carbon and magnesium oxide.

Graphene oxide can be in a form of a graphene oxide flake, dispersed graphene oxide flake, dispersed graphene oxide powder, graphene oxide powder, single layer graphene oxide (SLGO), multi-layered graphene oxide (MLGO), graphene oxide paper, chemical vapor deposition grown graphene on foils and wafers, graphene nano powder, graphene oxide, graphene in solution, reduced graphene oxide, reduced single layer graphene (SLG) coatings, graphite oxide, exfoliated graphite oxide, graphite oxide nano platelet, graphene oxide nano sheets, graphitic oxide, and/or graphitic acid, etc.

Graphene oxide (also called reduced graphite oxide, graphitic oxide, or graphitic acid) is a compound of carbon, oxygen, and hydrogen in variable ratios, obtained by treating graphite with strong oxidizers.

A maximally oxidized bulk product is yellow solid with C:O ratio between 2.1 and 2.9, which consists of loosely-bound layers, each being a substantially two-dimensional arrangement of carbon atoms in a “chicken-wire” (graphene) pattern, with epoxide groups (bridging oxygen atoms) and hydroxyl groups attached to both sides.

Graphene oxide can be used for a large-scale production and manipulation of graphene, a material with extraordinary electronic properties. Graphene oxide is an insulator, almost a semiconductor, with differential conductivity between approximately 1 and approximately 5×10−3 Siemens/cm at a bias voltage of approximately 10 volts. Being hydrophilic, graphene oxide disperses readily in water, breaking up into macroscopic flakes, mostly one layer thick. Chemical reduction of graphene oxide flakes can yield a suspension of graphene flakes.

Partial reduction can be achieved by treating suspended graphene oxide with hydrazine hydrate at approximately 100 degrees Celsius for approximately 24 hours, or by exposing graphene oxide to hydrogen plasma for a few seconds.

Reduction methods have been developed that do not use chemical solutions and can be performed at room temperature. A consumer camera flash can decompose graphene oxide to graphene. Dispersed graphene oxide flakes can also be shifted out of a dispersion (as in paper manufacture) and pressed to make a relatively strong graphene oxide paper.

Graphene products made by gas CVD on a metal substrate might produce very small quantities useful for thin film application. Oxidizing processes can utilize relatively strong oxidizers. Such oxidizers chemicals can be a cause for environmental concerns. Such graphene products might also contain a lot of defects.

Certain exemplary embodiments provide a physically functionalized GHC and/or a physically functionalized graphene, which can be used in a wide variety of applications; and represents a unique and specific graphene hybrid composite (GHC) which is further disclosed in the United States Patent Application Pub. No. US 2013/0116114 A1, publication date May 9 2013.

In certain exemplary embodiments, the pyrolysis under an unoxidizing environment of a combination between specific solid carbon sources such as wood dust and additives yields a natural hybrid composite comprised of graphene and other graphitic carbons in which the major components are carbon nanotube and graphene. This product is called graphene hybrid composite (GHC) showing superior electrical conductivity over than that of pure carbon nano tube and pure graphene. Manipulating the process and material set, a unique GHC and/or graphene product is achieved, which shows uniform small particles having bright colors and average particles size less than approximately 10 nanometers. The bright color is evidence of a monolayer structure. When the product has more layers, the color of the product can become darker due to the light scattering through multiple layer structure as one can frequently see in the multilayer carbon products of carbon black, graphite etc. They can be soluble in certain kind of solvents and in alkaline solution, which is the evidence of graphene oxide (GO). These particles in situ can be dispersed or dissolved in solvents and/or can be ready for casting into thin or thick films using wet coating process. Wet coating is low cost for large scale production compared to vacuum technique for thin films. This physically functionalized product is different from other products and can be converted into pure graphene and other nano carbons using suitable reduction agents, heat, and/or light sources. The unique physically functionalized products are formed in a reactor chamber, but not by chemical reactions using hazardous and strong oxidizers. Thus, the referenced product is named “physically functionalized GHC” (single layer) and physically functionalized graphene (single layer), which are the precursor of substantially single layer GHC and/or graphene. Functionalized graphene can be made by a “Hummer process” utilizing a large quantity of strong oxidizers such as concentrated sulfuric acid, nitric acid, KMnO4, hydrogen peroxide H2O2 or by modified Hummer process using phosphoric acid H3PO4. The physical functionalization provides functionalized graphene and GHC via a baking process and substantially no strong oxidizers, The physically functionalized element can be relatively safely and relatively easily manufactured at a relatively large scale without significant environmental concerns. The physically functionalized product can be used in a wide variety of applications regarding thin film, thick film, and powder format. The physically functionalized graphene and GHC precursor are produced by the microencapsulation process providing effective isolation of single molecule of solid organic carbon source on a specific template material.

The precursor of physically functionalized product can be prepared in a special way so that the single layer of carbon source can be well maintained before undergoing the pyrolysis under an unoxidizing gas environment.

The precursor can comprise mainly solid carbon sources and other additives such as separators, the carbon sources can also be gas carbon source molecules and/or liquid carbon source molecules in a substantially free molecule format or can be adsorbed on a solid substrate.

In order to achieve a real isolated single molecule of carbon source, the carbon source can be micro encapsulated through two major steps:
Step 1: adsorbing the single molecule of organic compound on a template; and
Step 2: further dividing the template into smaller species using electrostatic charge generating molecules.

The single molecules of organic compound which is carbon source is achieved through several known process such as dissolving and/or dispersing using organic solvents, acid, base which do not destroy the molecule, sonication, surfactant addition, combination of sonication and surfactant, and/or milling with small media, etc. A solvent having a relatively strong polar group is preferred, such as, an alcohol, ketone, halogenated solvent, and/or amide, etc.

Template materials can have a relatively large surface area, for example, the Brunauer-Emmett-Teller (“BET”) technique can be used to measure the surface area of a powder. In this case, the template material can have a surface area greater than approximately five (5) square meters/gram; and ranging up to approximately two thousand five hundred (2500) square meters/gram. Template materials can have a relatively small average particle size ranging between approximately five nanometers to several hundred microns.

Template materials can be selected from a group of substances having low surface adhesion or any nano materials selected from organic and inorganic salts, oxides such as but not limited to dimethyl siloxane, poly silanol —SiOH, fluoro polymer such as but not limited to polyvinyl fluorovinylidene, Teflon powder from Daikin Kogyo (a Japanese company), fume TiO2, MgO, and/or fume silica, CaCO3, and/or nano CaCO3, etc.

The adsorption of organic molecules onto the template surface is completed by a drying process to remove solvents. The organic molecules can be reaggregated on the surface template after being dried, even at a relatively small size. In order to achieve a real single molecule, secondary milling can be utilized to break the small aggregate/template down further. The secondary break down step or the step 2 in the microencapsulation is important. It had been reported that a single layer graphene can be formed on silica via CVD. However, the technique does not provide a best solution of obtaining pure and soluble graphene for large scale production. In certain exemplary embodiments, the second break down step (Step 2) can maintain an isolated molecule of a solid carbon source by a barrier comprising an electrostatic charge generator to achieve functionalized graphene and/or graphene hybrid composite (GHC), which can be used more easily for multiple applications of large scale production. Step 2 of the microencapsulation process is a physical milling process using small media together with electrostatic charge generator. Small media can be selected from various kinds of beads of various sizes including metal, glass, polymer, and/or ceramic, etc. For example, beads made from one or more metals such as, for example, zirconium, stainless steel, and/or titanium can be utilized. In other embodiments, salt, sugar, solid organic acids, solid organic acid salts, and/or any particulate and hard solid can be utilized. The electrostatic charge generator in a combination with template material, organic carbon source can generate electrostatic charge by friction to prevent the coagulation and/or reaggregation of organic carbon source single molecule in nano scale. The average particle size of milling media can range from approximately 100 micron to several thousand mm. The electrostatic charge generator is an insulator, which can comprise one or more of polymer, glass, ceramic, wood powder, and/or cellulosic materials, etc.

Carbon sources can be relatively low molecular weight molecules carrying carbon atoms having average molecular weight ranging between approximately 10 and approximately 100,000. The carbon sources can be relatively high molecular weight molecules such as polymers having carbon atoms on main chain or side chain with average molecular weight ranging between approximately 10 and several hundred million. Examples of substantial solid carbon sources are cellulosic materials such as rice, flour, starch, cotton, wood, animal fat, animal oils, vegetable oils, wax, saturated and unsaturated aliphatic, organic substances including meat, seafood, fish, fruit, vegetable, cereals, coffee bean, soybean, and/or any kind of bean, etc.

A separator is a substance that can help to separate and isolate carbon sources into as small a unit as practicable. A separator molecule can be a surfactant including an ionic and/or a nonionic surfactant. Separator molecules can also be catalysts selected from inorganic minerals, organic compound, rare earth elements, and/or organic and inorganic salts, etc.

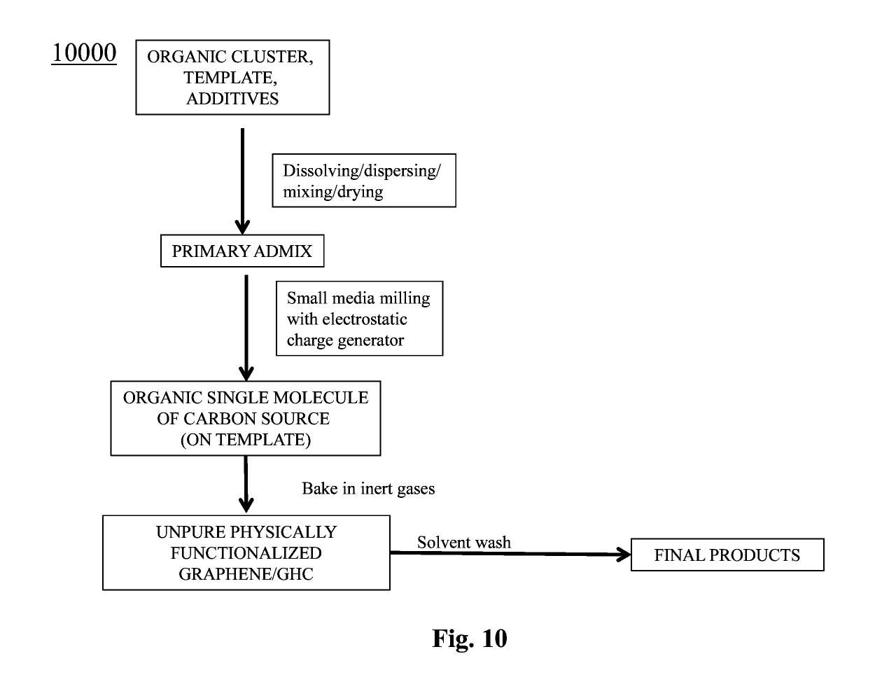

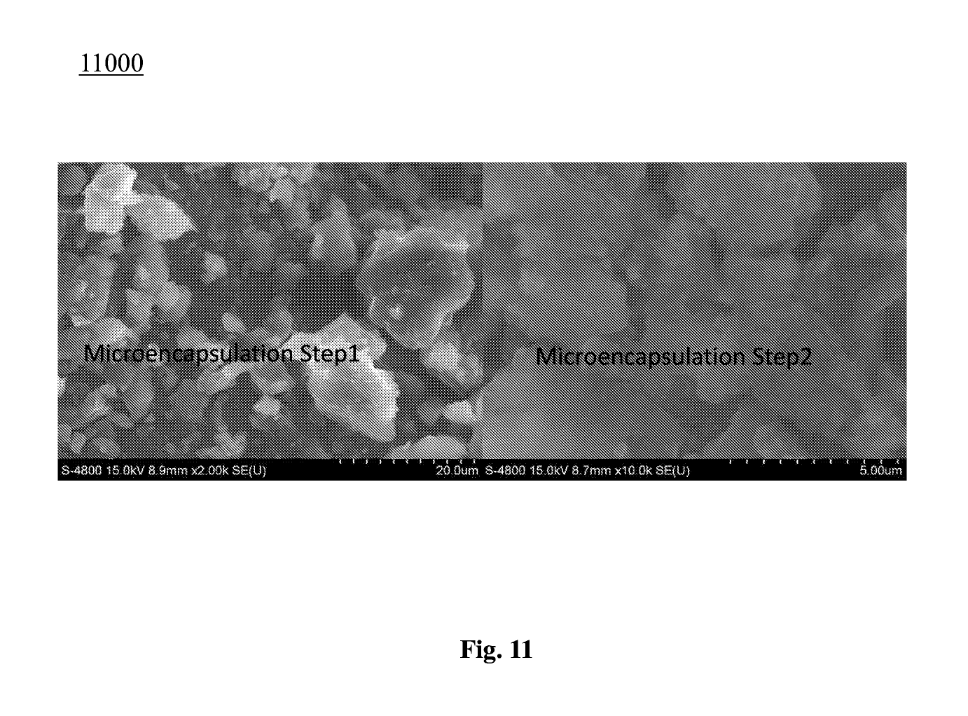

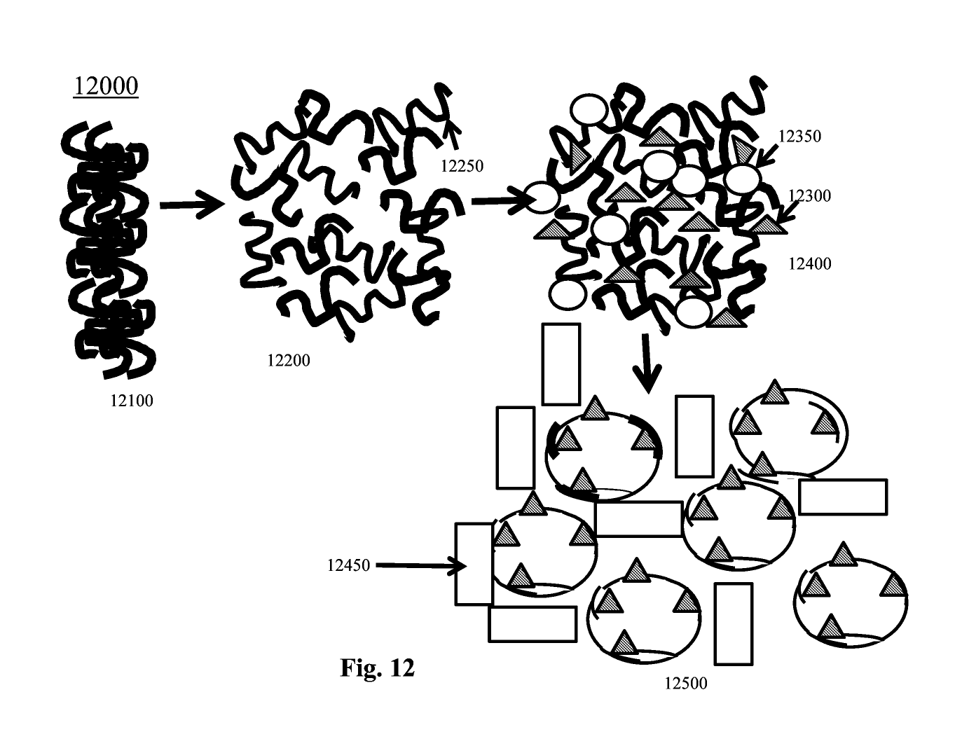

FIG. 10 is a flow chart of process producing physically functionalized monolayer graphene and GHC from an exemplary two step microencapsulation process. FIG. 11 shows a scanning electron microscopy (“SEM”) image of an organic molecule after two steps of a microencapsulation process. FIG. 12 shows the process of isolation organic molecule cluster into single molecule using a two-step microencapsulation technique. The real single molecule of a carbon source on a surface of a template can be burned in an inert gas such as, but not limited to, nitrogen and/or argon. A baking temperature can be between approximately 100 degrees Celsius and approximately 1200 degrees Celsius by either fast bake or slow bake depend upon reactor configuration. Bake times can range between approximately 1 second to approximately 10 hours, preferably, between approximately 5 minutes and approximately 5 hours.

FIG. 12 is schematic structure of a precursor from two step encapsulation process of an exemplary embodiment. A carbon source (CS) solid 12100 can be contacted with, and dispersed in, a solvent 12250 to for a carbon source liquid or dispersion 12200. A catalyst 12300 and a template 12350 can be added to carbon source liquid or dispersion 12200 such that an admix of carbon sources, template, and catalyst 12400 results. An electrostatic charge generator 12450 can be added to admix of carbon sources, template, and catalyst 12400 to forma solid precursor 12500 is formed after two-step microencapsulation 12500.

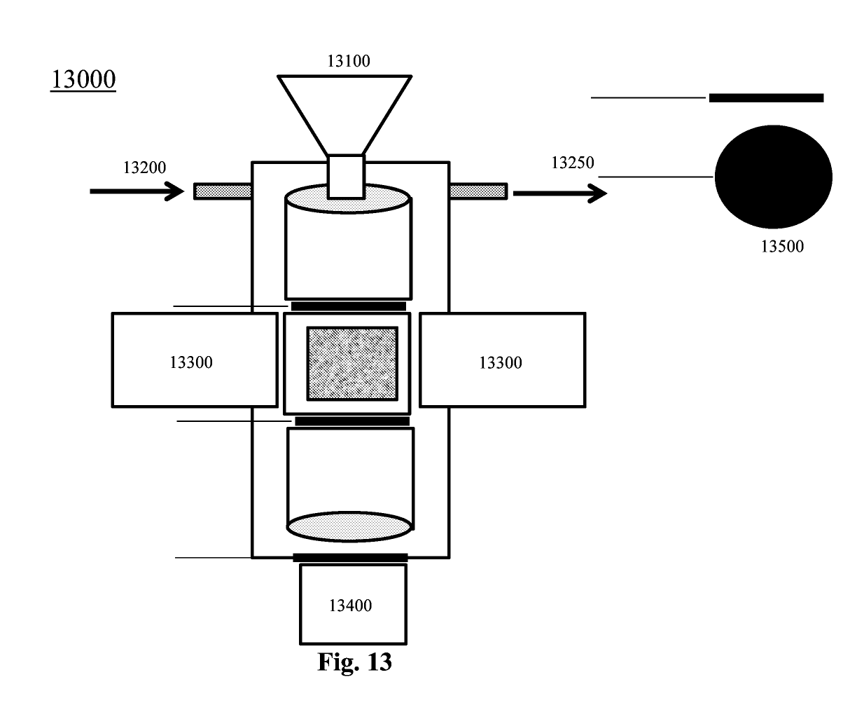

FIG. 13 is a block diagram of a continuous production reactor 13000, which can comprise a raw material feeder 13100. An inlet stream of nitrogen gas can be fed to system 13000, which results in a nitrogen outlet stream 13250. System 13000 can comprise a heater 13300, which can be adapted to increase a temperature of components processed in continuous production reactor 13000. Products flowing out of continuous production reactor 13000 pass to a product receiver 13400. Continuous production reactor 13000 can comprise a rotary separator between chambers 13500, which can be adapted to deliver the precursor, which had been exposed to vacuum and nitrogen gas (“N2”) to a preheated chamber or to deliver the physically functionalized product from the reactor chamber to the receiving area before being taken out of reactor One advantage of physically functionalized GHC and/or physically functionalized graphene is the capability of making large dimension thin films without using vacuum technique. Similar to transparent conductor application, a wet solution can be coated on a large dimensioned surface using conventional web coating techniques such as hopper coater, blade coater, and/or dip coater, etc.; which can be followed with a drying process. After being thermally treated, the electrical conductive web using GHC and/or graphene can be used for the manufacturing of various kinds of microelectronic devices including, but not limited to, complementary metal-oxide-semiconductor (“CMOS”), printed electronics, and/or supra capacitors, etc.

Certain exemplary embodiments can provide various kinds of physically functionalized products.

Certain exemplary embodiments can utilize a heat resistant and unoxidized reaction chamber having mechanism of mixing and agitating raw materials. The reaction chamber can be selectively designed so it can provide different mixing and agitating mechanisms during reaction. The reaction chamber can be a horizontal, vertical, or a substantially round bottom flask, etc.

A free radical generator can perform the function of generating free radicals from variable carbon sources. The free radical generation elements can be a heating element, infra-red, irradiation, plasma, and/or magnetic heater, etc.

A temperature controller can be utilized, which is adapted to control reaction chamber temperature.

A gas introducing mechanism and gas flow meter system can be used to control the atmosphere of the reactor chamber.

Certain exemplary embodiments provide a method comprising isolating a single molecule of a solid organic compound via a microencapsulation process. The single molecule can be adapted for use in at least one of a drug, pharmaceutical application, microelectronic device, bioengineering application, biomedical product, agricultural product, or agricultural medicine. The single molecule can be a biomedical product precursor.

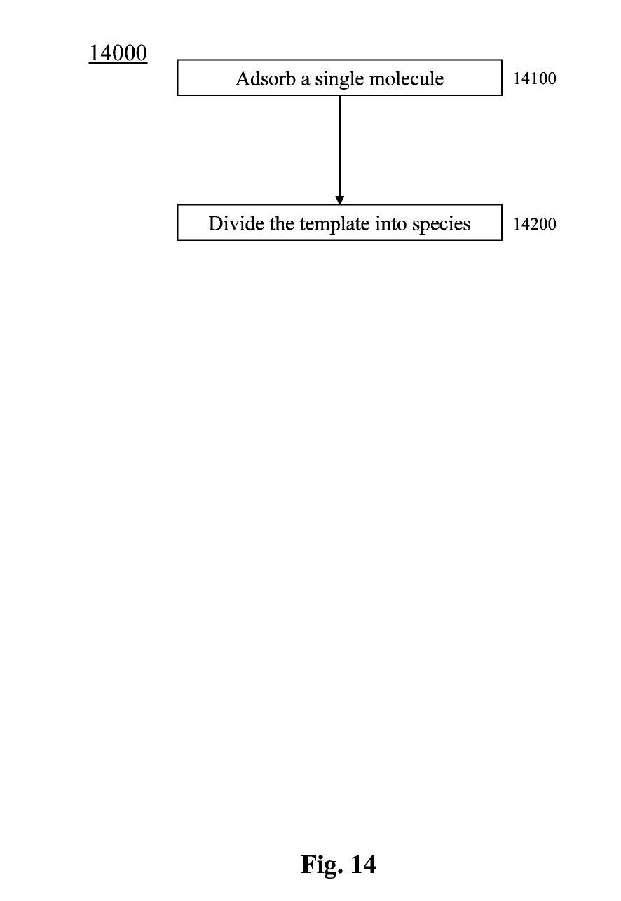

FIG. 14 is a flowchart of an exemplary embodiment of a method 14000, which can be a microencapsulation process and can comprise:
at activity 14100, adsorbing the single molecule, which can be an organic molecule, on a template; and
at activity 14200, dividing the template into species using electrostatic charge generating molecules.

The template can:
comprise a nano material;
comprise at least one of dimethyl siloxane, poly silanol —SiOH, a fluoropolymer, Teflon powder, fume TiO2, MgO, or fume silica;
comprise a metallic catalyst;
comprise a molecular divider;
have a surface area greater than approximately five square meters per gram such as measured using a Brunauer-Emmett-Teller technique; and/or
have an average particle size greater than approximately one nanometer;
be divided via a physical milling process using small media together with an electrostatic charge generation molecule; etc.

The electrostatic charge generation molecule can have a dielectric constant ranging between:
approximately 0.5 and approximately 10;
approximately 1.0 and approximately 7.0; and/or
approximately 1.3 and approximately 5.0, etc.

The single molecule can be an organic molecule or an organic compound comprising at least one carbon atom; the single molecule adapted to act as a carbon source. The single molecule can be adapted for generation of physically functionalized graphene, graphene hybrid composite, graphene oxide, and/or reduced graphene oxide, etc. The physically functionalized graphene, graphene hybrid composite, graphene oxide, or reduced graphene oxide can have one or more of the following properties:
is a powder comprising particles having average diameter less than approximately 10 nanometers; and
when analyzed via Raman spectroscopy:
   shows a major 2D band at approximately 2650 l/centimeter;
   shows a minor G band at approximately 1350 l/centimeter and approximately 1575 l/centimeter; and
   shows an intensity ratio of 2D band over G band greater than 1.

The graphene hybrid composite can comprise a carbon nano-tube, graphite, graphene, graphene oxide, or amorphous carbon created via pyrolysis of a combination of solid carbon sources with specific additives under an unoxidizing environment.

The graphene can be a graphene hybrid composite. The graphene can be soluble in an organic solvent. The graphene can be soluble in an alkaline solution. The physically functionalized graphene and/or the physically functionalized GHC can be converted into pure graphene or a graphene hybrid composite showing high conductivity when treated with light, heat, or a reduction agent. The reactor producing the physically functionalized graphene, graphene hybrid composite, graphene oxide, or reduced graphene oxide can be at least one of a vertical, horizontal, round bottomed flask, or irregular shape. A reactor producing the physically functionalized graphene, graphene hybrid composite, graphene oxide, or reduced graphene oxide can generate free radicals via at least one of a carbon generator, waste gas exhaust mechanism, or reaction precursor agitation mechanism. The physically functionalized graphene, graphene hybrid composite, graphene oxide, or reduced graphene oxide can be produced via a carbon generator, the carbon generator adapted to generate free radicals via a heating element comprising at least one of an infra-red heater, plasma heater, or resistor heater.

### Definitions

When the following terms are used substantively herein, the accompanying definitions apply. These terms and definitions are presented without prejudice, and, consistent with the application, the right to redefine these terms during the prosecution of this application or any application claiming priority hereto is reserved. For the purpose of interpreting a claim of any patent that claims priority hereto, each definition (or redefined term if an original definition was amended during the prosecution of that patent), functions as a clear and unambiguous disavowal of the subject matter outside of that definition.
ρ—bulk electrical resistivity.
a—at least one.
activity—an action, act, step, and/or process or portion thereof
adapted to—made suitable or fit for a specific use or situation.
additive—a substance added to something that alters the properties of the something.
adsorb—to adhere to a surface.
agricultural—concerning the production of crops, livestock, or poultry.
alkaline solution—a liquid having a pH of above 7.0.
amorphous carbon—free, reactive carbon that substantially lacks any crystalline structure.
and/or—either in conjunction with or in alternative to.
apparatus—an appliance or device for a particular purpose.
application—a use or purpose to which something is put.
battery—one or more electrochemical cells adapted to convert stored chemical energy into electrical energy.
binder—a substance that causes cohesion between other substances in a system.
bioengineering—the application of engineering principles and techniques to problems in medicine and biology.
biomedical—the application of the natural sciences, especially the biological and physiological sciences, to clinical medicine.
bipolar plate—conductive plate in a fuel cell stack that acts as an anode for one cell and a cathode for an adjacent cell. The plate can comprise a metal or a conductive polymer (which can be a carbon-filled composite).
blend—to mix together.
bond—a cohesive adhesion of sub stances.
Brunauer-Emmett-Teller technique—a surface area determination method based upon measuring the adsorption of gas molecules on a solid surface.
can—is capable of in at least some embodiments.
carbon generator—a system adapted to produced substantially unoxidized carbon via pyrolysis.
carbon nanofiber—a substantially cylindrical nano structure with graphene layers arranged as stacked cones, cups, or plates.
carbon nanorod—a nanocrystalline form of diamond.
carbon nanotube—a carbon nanofiber comprising graphene layers wrapped into substantially perfect cylinders.
carbon nanowires—a nanostructure comprising carbon and having a diameter of approximately a nanometer (10⁻⁹ meters) and in which electrons are quantum confined laterally.
ceramic—an inorganic, nonmetallic solid.
chamber—an enclosed compartment.
character recognition—an identification by electronic means of printed or written characters.
charge transport molecules—a group of atoms, bonded together, which are capable of conducting an electrical charge, via electrons or holes, responsive to an application of an electrical potential.
compound—a substance comprising two or more periodic table elements.
comprising—including but not limited to.
conduct—to transmit electrical energy.
conductive—adapted to transmit electrical energy.
continuous production process—a method adapted to make a substance substantially without interruption for a time period exceeding at least one day.
conjugate—two or more alternating double chemical bonds in a system.
convert—to change into another chemical compound or structure.
crosslink—a bond, atom, or group linking the chains of atoms in a polymer, protein, or other complex organic molecule.
device—a machine, manufacture, and/or collection thereof
dielectric constant—the ratio of the amount of electrical energy stored in a material by an applied voltage, relative to that stored in a vacuum.
digital fabrication—computer controlled manufacture.
digital printing ink—an ink adapted for use in printing from a digital based image directly to a variety of media.
disperse—to cause particles to separate uniformly throughout a substance.
dissolve—to cause a solute to be mixed with a liquid solvent.
divide—to separate into parts.
drug—a chemical substance used in the treatment, cure, prevention, or diagnosis of disease or used to otherwise enhance physical or mental well-being.
dry—substantially water free.
electrically conductive—having an electrical conductivity that is greater than approximately 1,000 Siemens/meter.
electrode—an electrical conductor through which a current enters or leaves a nonmetallic medium, as an electrolytic cell, arc generator, vacuum tube, or gaseous discharge tube.
electrolytic polymer—a polymer which can transport ions an electrically conductive or semiconductive compound of relatively high molecular weight derived either by the addition of many smaller molecules or by the condensation of many smaller molecules with the elimination of water, alcohol, or the like.
electromagnetic—capable of being magnetized by via an electric current in a surrounding coil.
electromagnetic shielding—a barrier, made of conductive and/or magnetic materials, adapted to reduce an electromagnetic field in a space by blocking the field.
electrostatic charge generating molecule—a molecule that in combination with a template and organic carbon source can generate electrostatic charge to prevent the coagulation and/or reaggregation of organic carbon source single molecules at a nano scale.
electron transport molecules—a group of atoms, bonded together, which are capable of conducting an electrical charge, via electrons, responsive to an application of an electrical potential.
electroplate—to plate or coat with a metal by electrolysis.
element—a component or constituent of a whole device or system.
energy storage—a repository adapted to contain reserves having a capacity of a body or system to do work.
expose—to allow contact with.
ferrofluid—a liquid which becomes strongly magnetized in the presence of a magnetic field.
flake—a substantially planar lattice of carbon atoms.
flask—a bottle with a narrow neck and adapted for use in a laboratory.
fluoropolymer—a fluorocarbon based polymer with multiple carbon-fluorine bonds.
free radical—an atom, molecule, or ion that has unpaired valence electrons or an open electron shell.
fuel cell—a system adapted to convert chemical energy from a fuel into electricity through a chemical reaction with oxygen or another oxidizing agent.
fume silica—an amorphous (non-crystalline) polymorph of silicon dioxide in a form of an ultrafine powder having a particle diameter of less than 200 nanometers.
functional group—a group of atoms responsible for the characteristic behavior of the class of compounds in which the group occurs.
generate—to produce.
graphene hybrid composite (“GHC”)—a substance having properties defined in U.S. patent application Ser. No. 13/331,330, which was filed 20 Dec. 2011.
glass—a hard brittle non-crystalline solid comprising a fused mixture of oxides.
graphene—an allotrope of carbon having a structure of approximately one-atom-thick planar sheets of sp2-bonded carbon atoms in a honeycomb crystal lattice.
graphene oxide—a compound of carbon, oxygen, and hydrogen in variable ratios, obtained by treating graphite with oxidizers.
graphite—an electrically conductive allotrope of carbon that can be in the form of a flake, fine particle, or lump.
high conductivity—having an electrical conductivity that is greater than 1700 siemens per meter.
hole transport molecules—a group of atoms, bonded together, which are capable of conducting an electrical charge, via hole, responsive to an application of an electrical potential.
horizontal—substantially parallel to level ground.
hybrid composite—a material comprising two constituents at the nanometer or molecular level.
hydroxylate—to introduce a hydroxyl group (—OH) into an organic compound.
infra-red heater—a body with a higher temperature which transfers energy to a body with a lower temperature through electromagnetic radiation.
ink—a liquid or paste that contains pigments and/or dyes adapted to produce electrically conductive patterns when used in a suitable system.
inorganic—pertaining to chemical compounds that are not hydrocarbons or derivatives thereof.
insulator—a material in which internal electric charges do not flow freely, and which therefore substantially does not conduct an electric current under the influence o fan electric field.
intensity ratio—a height of a first predetermined Raman spectrum peak divided by the height of a second predetermined Raman spectrum peak.
iron relative—a compound comprising at least one of iron inorganic salts, iron organic salts, iron chelates, iron organo metallic compounds.
irregular shape—having a contour that substantially lacks symmetry.
isolate—to obtain a substance in a substantially uncombined or pure state.
lacquer—a varnish that dries by solvent evaporation and/or a curing process to produce a relatively durable finish.
level—a measurable amount.
light emitting diode—a semi-conductor adapted to produce light by a solid state process called electroluminescence.
liquid—a state of matter that occupies a substantially fixed volume but has no fixed shape.
matrix—a material in which other substances are embedded.
may—is allowed and/or permitted to, in at least some embodiments.
main chain—a longest contiguous series of carbon atoms or groups bonded together in an organic molecule.
major 2D band—a peak from a Raman spectrum that is located between 2600 and 2750 l/centimeter.
measure—to ascertain a value by comparison with a standard.
medicine—of or pertaining to any substance or substances used in treating disease or illness.
metal—any of a number of chemical elements, such as iron or copper, that are often lustrous ductile solids, have basic oxides, form positive ions, and are relatively good conductors of heat and electricity.
metallic catalyst—a substance that comprises a metal element from the periodic table; the substance adapted to cause or accelerate a chemical reaction substantially without itself being affected.
metal oxide—a metal that has been chemically bonded to, and which shares electrons with, an oxygen atom.
method—a process, procedure, and/or collection of related activities for accomplishing something.
microelectronic—of or pertaining to a devices or systems involving the flow of electrons and comprising components too small to be seen by the naked eye of a human.
microencapsulation process—a method that encloses a substance in a small encasement having a diameter of between 20-150 microns.
microwave oven—an electrically operated system that comprises a chamber or compartment adapted to retain and heat substances; the system uses high-frequency electromagnetic waves that penetrate the substances, causing molecules of the substances to vibrate and generate heat.
mineral—any of a class of substances occurring in nature, usually comprising inorganic substances of definite chemical composition and usually of definite crystal structure, but sometimes also including rocks formed by these substances as well as certain natural products of organic origin, as asphalt or coal.
minor G band—a peak from a Raman spectrum that is located between 1300 and 1600 l/centimeter.
mold—a hollow form or matrix for giving a particular shape to something in a molten or plastic state.
molecular divider—a substance adapted to cause a molecule to be separated into two or more parts.
nano cable—plastic tube comprising a novel nano material powder inside.
nano carbon material—a structure comprising carbon that has a maximum size of one tenth of a micrometer in at least one dimension.
nano material—a substance, the single units of which is sized (in at least one dimension) between 1 and 1000 nanometers.
nano metallic element—a part of a nano carbon material that comprises at least on atom of a metal.
nano particle—an object having a maximum dimension of approximately 10,000 nanometers that behaves as a whole unit with respect to its transport and properties.
nano-platelets—nanoparticles comprising stacks of graphene that are 1 to 15 nanometers thick, with diameters ranging from sub-micrometer to 100 micrometers.
NTL—particular polymeric additives.
obtain—to come into possession of get, acquire, and/or procure.
organic—a compound that comprises carbon.
oven—a chamber used adapted for heating a substance.
oxide—a chemical compound that contains at least one oxygen atom in its chemical formula.
paper—a thin, flexible, and substantially planar material produced by pressing together moist fibers and drying them into flexible sheets.
particle—a small piece of matter.
paste—a mixture or material that is malleable.
peak—a sharp increase in a spectral plot followed by a sharp decrease.
pharmaceutical—of or related to drugs.
phosphorescent—having a property of being luminous at temperatures below incandescence.
physically functionalize—to form in a reactor chamber substantially without chemical reactions taking place in the reactor chamber during formation.
physical milling—reducing particle sizes of a substance via grinding or pulverizing.
placed under—subjected to.
plasma heater—a system adapted to increase a temperature via an ionized gas in an electric discharge or spark.
plastic—any one of a large number of synthetic, usually organic, materials that have a polymeric structure and can be shaped when soft and then hardened.
polar—being or having a molecule in which there is an uneven distribution of electrons and thus a dipole moment.
polyamic—an organic molecule having a plurality of amide functional groups.
polyimide—an organic molecule having a plurality of imide functional groups.
polymer—a macromolecule comprising repeating structural subunits that are typically connected by covalent chemical bonds.
powder—a solid that has a maximum particle diameter that is less than approximately 100 microns.
precursor—a chemical that is transformed into another compound or substance.
present—being in a specified thing.
printed electronics—components produced via a method wherein electrically functional electronic or optical inks are deposited on the substrate, to create active or passive devices, such as thin film transistors or resistors.
produce—to make or manufacture.
product—a substance obtained via a process.
product receiving chamber—a chamber adapted to receive physically functionalized graphene, graphene hybrid composite, graphene oxide, or reduced graphene oxide.
provide—to furnish, supply, give, and/or make available.
pure—substantially free from anything of a different or contaminating kind.
pyrolyze—to thermochemically decompose an organic material at a temperature above approximately 200 degrees Celsius in the substantial absence of oxygen.
pyrolysis—a thermochemical decomposition of organic material at a temperature above approximately 200 degrees Celsius in the substantial absence of oxygen.
Raman spectrum—a result of a spectroscopic technique used to observe vibrational, rotational, and other low-frequency modes in a system. The spectroscopic technique relies on inelastic scattering, or Raman scattering, of monochromatic light, usually from a laser in the visible, near infrared, or near ultraviolet range. The laser light interacts with molecular vibrations, phonons or other excitations in the system, resulting in the energy of the laser photons being shifted up or down. The shift in energy gives information about the vibrational modes in the system.
rare earth element—one of the fifteen lanthanides, scandium, or yttrium.
rare earth mineral—a mineral which comprises, as a major constituent, one or more rare earth elements.
raw material—a solid carbon-based substance adapted to yield a graphene hybrid composite when subjected to pyrolysis.
chemical reaction—a process that involves changes in the structure and energy content of atoms, molecules, or ions but not their nuclei.
reaction precursor agitation mechanism—a system adapted to produce a free radical precursor via vigorous motion of a substance.
reactor—a container for processes in which the substances involved undergo a chemical reaction.
reduced graphene oxide—graphene produced via reduction of graphite oxide.
reduction agent—an element or compound that loses an electron to another chemical species in a redox chemical reaction
resistor heater—a system adapted to increase a temperature of something due to an electrical current flowing through an electrical resistance.
rotary separating device—a device turning on an axis that is adapted to divide one substance from another.
round bottomed flask—types of flasks having spherical bottoms used as laboratory glassware.
semi-conducting—having a conductivity roughly in the range of 10³ to 10⁸ siemens per centimeter.
side chain—a chemical group that is attached to a core part of the molecule called “main chain” or backbone. The placeholder R is often used as a generic placeholder for alkyl (saturated hydrocarbon) group side chains in chemical structure diagrams. To indicate other non-carbon groups in structure diagrams, X, Y, or Z is often used.
silk printing—a printing technique that uses a silk material to support an ink-blocking stencil. The stencil forms open areas of the silk that transfer ink or other printable materials which can be pressed through the silk as a sharp-edged image onto a substrate. A blade is moved across the screen stencil, forcing or pumping ink into the mesh openings for transfer by capillary action.
single molecule—one of a smallest possible physical unit of an element or compound, consisting of one or more like atoms in an element and two or more different atoms in a compound.
size—a physical extent of.
small media—a substance
solid—a physical state of a substance in which the substance resists changes in size and shape.
solid carbon source—an organic substance that is in a physical state in which it resists changes in size and shape.
solvent—a substance adapted to dissolve another solid, liquid, or gaseous solute.
species—a substance adapted for use in milling that has a diameter of less than 10 millimeters.
specific—particular, or definite.
substantially—to a great extent or degree.
substitute groups—a group of atoms that can react with an organic molecule to replace an existing atom or group of atoms in the organic molecule.
surface area—a total area of an object's faces and curved surfaces.
super capacitor—an electrochemical capacitor that lacks a dielectric, the capacitance value of which is determined by (1) electrostatic storage of electrical energy within Helmholtz double layers achieved on a phase interface between the surface of electrodes and an electrolyte; and (2) electrochemical storage of electrical energy achieved by a faradaic electron charge-transfer by peculiar adsorbed ions with redox reactions.
surfactant—a substance adapted to reduce the surface tension of a liquid.
system—a collection of mechanisms, devices, machines, articles of manufacture, processes, data, and/or instructions, the collection designed to perform one or more specific functions.
technology—the application of practical sciences to industry or commerce.
Teflon—polytetrafluoroethylene, which can be obtained from DuPont Co. (a United States company) or from Daikin Kogyo (a Japanese company).
template—molecular structure of a compound that serves as a pattern for the production of the structure of another specific compound in a reaction.
thermogravimetrically stable—substantially not changing in weight responsive to a change in temperature over a predetermined range.
thermoset—having the property of becoming permanently hard and rigid when heated or cured.
thin film—a layer of material ranging from fractions of a nanometer to several micrometers in thickness.
transistor—a semiconductor device comprising at least three terminals and adapted to amplify and/or switch electronic signals and power.
transparent conductor—an electrically conductive material that is substantially optically transparent.
tubular—having a substantially cylindrical shape.
two theta values—detected intensities of an X-ray beam at a given detector swing angle (the detector swing angle of an X-ray diffraction system is defined as “two theta”).
unoxidizing environment—surroundings conducive to cause a substance to not undergo a decrease in the number of electrons.
unoxidizing gas—a gas conducive to cause a substance to not undergo a decrease in the number of electrons.
vacuum—a region in which gas is present at a low pressure.
vertical—being in a position or direction that is substantially perpendicular to the plane of the horizon.
via—by way of and/or utilizing.
waste gas exhaust mechanism—a method comprising the removal of a gas produced via a combustion or chemical process from a system.
wood—xylem.
X-ray diffraction—a substantially non-destructive analytical technique adapted to determine information about crystallographic structure, chemical composition, and/or physical properties of materials based on detecting reflected intensities of X-ray beams at predetermined angels of incidence (theta).

### Note

Still other substantially and specifically practical and useful embodiments will become readily apparent to those skilled in this art from reading the above-recited and/or herein-included detailed description and/or drawings of certain exemplary embodiments. It should be understood that numerous variations, modifications, and additional embodiments are possible, and accordingly, all such variations, modifications, and embodiments are to be regarded as being within the scope of this application.

Thus, regardless of the content of any portion (e.g., title, field, background, summary, description, abstract, drawing figure, etc.) of this application, unless clearly specified to the contrary, such as via explicit definition, assertion, or argument, with respect to any claim, whether of this application and/or any claim of any application claiming priority hereto, and whether originally presented or otherwise:
there is no requirement for the inclusion o f any particular described or illustrated characteristic, function, activity, or element, any particular sequence of activities, or any particular interrelationship of elements;
no characteristic, function, activity, or element is “essential”;
any elements can be integrated, segregated, and/or duplicated;
any activity can be repeated, any activity can be performed by multiple entities, and/or any activity can be performed in multiple jurisdictions; and
any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any claim element is followed by a drawing element number, that drawing element number is exemplary and non-limiting on claim scope. No claim of this application is intended to invoke paragraph six of 35 USC 112 unless the precise phrase “means for” is followed by a gerund.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such material is specifically not incorporated by reference herein.

Accordingly, every portion (e.g., title, field, background, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

What is claimed is:

1. A method comprising:
isolating a single molecule of a solid organic compound via a microencapsulation process, said single molecule adapted for use in at least one of a drug, pharmaceutical application, microelectronic device, bioengineering application, biomedical product, agricultural product, or agricultural medicine, said microencapsulation process comprising:
adsorbing said single molecule on a template; and
dividing said template into species using electrostatic charge generating molecules;
wherein:
said template comprises a nano material;
said template has a surface area greater than five square meters per gram;
said template has an average particle size greater than one nanometer;
said template is divided via a physical milling process using small media together with an electrostatic charge generation molecule;
said single molecule is an organic molecule or an organic compound comprising at least one carbon atom; said single molecule adapted to act as a carbon source;
said single molecule adapted for generation of physically functionalized graphene, graphene hybrid composite, graphene oxide, or reduced graphene oxide;
wherein said physically functionalized graphene, graphene hybrid composite, graphene oxide, or reduced graphene oxide:
is a powder comprising particles having average diameter less than 10 nanometers; and
when analyzed via Raman spectroscopy:
shows a major 2D band at approximately 2650
shows a minor G band at approximately 1350 l/centimeter and approximately 1575 l/centimeter; and
shows an intensity ratio of 2D band over G band greater than 1.

2. The method of claim 1, wherein:
said graphene hybrid composite comprises a carbon nano-tube, graphite, graphene, graphene oxide, or amorphous carbon created via pyrolysis of a combination of solid carbon sources with specific additives under an unoxidizing environment.

3. The method of claim 1, wherein:
a reactor producing said physically functionalized graphene, graphene hybrid composite, graphene oxide, or reduced graphene oxide generates free radicals via at least one of a carbon generator, waste gas exhaust mechanism, or reaction precursor agitation mechanism.

4. The method of claim 1, wherein:
a reactor producing said physically functionalized graphene, graphene hybrid composite, graphene oxide, or reduced graphene oxide, said reactor comprising:
a raw material chamber, wherein raw materials are exposed to vacuum and an unoxidizing gas;
a reactor chamber, said reactor chamber adapted to be placed under a predetermined level of vacuum and to be filled with an unoxidizing gas such that a chemical reaction occurs; and
a product receiving chamber, wherein each of said raw material chamber, said reactor chamber, and said product receiving chamber connected by rotary separating devices, which allow a substantially continuous production process.

5. The method of claim 1, wherein:
said physically functionalized graphene, graphene hybrid composite, graphene oxide, or reduced graphene oxide is produced via a carbon generator, said carbon generator adapted to generate free radicals via a heating element comprising at least one of an infra-red heater, plasma heater, or resistor heater.

6. The method of claim 1, wherein:
a reactor producing said physically functionalized graphene, graphene hybrid composite, graphene oxide, or reduced graphene oxide is at least one of a vertical, horizontal, round bottomed flask, or irregular shape.

7. The method of claim 1, wherein:
said single molecule is a biomedical product precursor.

8. The method of claim 1, wherein:
said template has a surface area of greater than 5 square meters/gram measured using a Brunauer-Emmett-Teller technique.

9. The method of claim 1, wherein:
said template comprises at least one of dimethyl siloxane, poly silanol —SiOH, a fluoropolymer, Teflon powder, fume TiO2, MgO, fume silica, a nano material selected from organic and inorganic salts, an oxide, CaCO3, or nano CaCO3.

10. The method of claim 1, wherein:
said template comprises a metallic catalyst and a molecular divider.

11. The method of claim 1, wherein:
said electrostatic charge generation molecule has a dielectric constant ranging between 0.5 and 10.

12. The method of claim 1, wherein:
said electrostatic charge generation molecule has a dielectric constant ranging between 1.0 and 7.0.

13. The method of claim 1, wherein:
said electrostatic charge generation molecule has a dielectric constant ranging between 1.3 and 5.0.

14. The method of claim 1, wherein:
said graphene is a graphene hybrid composite.

15. The method of claim 1, wherein:
said method physically functionalizes said graphene.

16. The method of claim 1, wherein:
said graphene is soluble in an organic solvent.

17. The method of claim 1, wherein:
said graphene is soluble in an alkaline solution.

18. The method of claim 1, wherein:
said physically functionalized graphene or said graphene hybrid composite is converted into pure graphene or a graphene hybrid composite showing high conductivity when treated with light, heat, or a reduction agent.
